(19) United States
(12) Patent Application Publication
(10) Pub. No.: US 2023/0059878 A1
(43) Pub. Date: Feb. 23, 2023

(54) Bed Pad Device

(71) Applicant: Ana Prior, Desert Hot Springs, CA (US)

(72) Inventor: Ana Prior, Desert Hot Springs, CA (US)

(21) Appl. No.: 17/489,880

(22) Filed: Sep. 30, 2021

Related U.S. Application Data
(60) Provisional application No. 63/234,797, filed on Aug. 19, 2021.

(51) Int. Cl. A61G 7/00; A61G 7/057; A61G 7/10

(52) U.S. Cl. CPC A61G 7/001; A61G 7/057; A61G 7/1023; A61G 2200/32

(57) ABSTRACT

A bed pad device is disclosed, wherein the device is comprised of a generally rectangular body with at least one strap on either side of the body that may contain a hook or loop surface. An invalid user may be placed on top of the device, wherein the strap on the left side of the body is designed to meet the corresponding strap on the right side of the body, when the device is folded over itself, thereby forming a hollow cylindrical shape. The hook and loop surfaces of the straps may then be pressed together, forming a bond which holds the device together and secures the user in a desired position. Further, the straps can be wrapped around the railing of a bed, such that the position of the invalid user can be secured.

### CROSS-REFERENCE TO RELATED APPLICATION

The present application claims priority to, and the benefit of, U.S. Provisional Application No. 63/234,797, which was filed on Aug. 19, 2021 and is incorporated herein by reference in its entirety.

### FIELD OF THE INVENTION

The subject matter disclosed and claimed herein, in one embodiment thereof, comprises a bed pad device. The device is comprised of a generally rectangular body with at least one strap on either side of the body that may contain a hook or loop surface. An invalid user may be placed on top of the device, wherein the strap on the left side of the body is designed to meet the corresponding strap on the right side of the body, when the device is folded over itself, forming a hollow cylindrical shape. The hook and loop surfaces of the straps may then be pressed together forming a bond which holds the device together and secures the user in a desired position. Accordingly, the present disclosure makes specific reference thereto. Nonetheless, it is to be appreciated that aspects of the present invention are also equally applicable to other like applications, devices and methods of manufacture.

### BACKGROUND

There are many people who find themselves bedridden for a multitude of specific reasons. Often times, these people may be rendered so incapable and unable to function that they are essentially immobile. Long term periods of laying in the same position and in the same bed may lead to many different undesirable and dangerous health outcomes. Over time, medical bedding that is used in hospitals or used in home care may constantly be exposed and imbued with sweat, oils, contaminants, bodily fluids and other unpleasant substances. These harmful substances will often continue to linger and attach themselves to the bedridden patient. Further, the spread of potential diseases and the increased risk of infection emphasize the need for consistent cleaning of the bed and bedridden person. However, this process can be extremely involved when dealing with highly sensitive, immobile and otherwise invalid bedridden patients.

For instance, issues arise when an attendant or caregiver attempts to maneuver a person who may have a contagious disease. However, requiring a caregiver to maneuver the invalid patient by touching the patient directly can lead to dangerous outcomes. Other issues may arise when an invalid patient is afflicted with a painful injury, and further contacting different parts of the bedridden patient is unfeasible due to said injury. Moreover, an invalid user remaining dormant in the same position for an extended period of time can also lead to other physically undesirable and dangerous outcomes such as the development of bedsores.

Therefore, to reduce the occurrence of the aforementioned undesirable scenarios, there exists a long-felt need in the art for an improved bed pad. Specifically, there exists a long-felt need in the art for a bed pad device that allows for the repositioning of an invalid user without the infliction of pain or discomfort to said user. Likewise, there exists a long-felt need in the art for a bed pad device that allows for the repositioning of an invalid user, without requiring a caregiver to physically come into contact with the invalid user. Additionally, there exists a long-felt need in the art for a bed pad device that is durable, yet comfortable for an invalid user who may be required to lay upon the pad for long periods of time. There is also a long-felt need in the art for a bed pad device which is easily washable, such that a caregiver can effectively mitigate the lingering, growth and spread of harmful substances and undesirable odors.

The subject matter disclosed and claimed herein, in one embodiment thereof, comprises a bed pad device. The device is comprised of a generally rectangular body with at least one strap on either side of the body, that may contain a hook or loop surface. An invalid user may be placed on top of the device, wherein the strap on the left side of the body is designed to meet the corresponding strap on the right side of the body, when the device is folded over itself forming a hollow cylindrical shape. The hook and loop surfaces of the straps may then be pressed together, forming a bond which holds the device together and secures the user in a desired position. Further, the straps can be wrapped around the railing of a bed, such that the position of the invalid user can be ensured.

In this manner, the bed pad device of the present invention accomplishes all of the forgoing objectives and provides a device which can easily and safely reposition an invalid user. Further, the bed pad device allows the straps to be secured to a bed railing, such that the position of the invalid user within the device can be maintained. In this manner, the caregiver can, amongst other things, clean underneath the invalid user, replace objects making up the bed, clean the underside of the invalid user, etc. The device also offers a barrier between the caregiver and the invalid, which allows the caregiver to move the invalid user without direct contact. Moreover, the device can be fitted with a myriad of different materials that accomplish different desired functions.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bed pad device that provides a caregiver with the ability to reposition a bedridden user. A sheep skin layer acts as a barrier between the invalid user and the body of the device. In one embodiment, the sheep skin layer may be comprised of a series of hook surfaces, such that it may be removably-attached to the body of the device by being pressed into a series of loop surfaces located on the body. In this manner, the sheep skin surface can detach for cleaning or replacement purposes. The body is also preferably manufactured from a durable material that does not rip when pulled or stretched. In different embodiments, the body may have an antimicrobial and antibacterial coating.

The body may further have at least one strap that emerges from at least one of the four corners of the body. The preferred embodiment of the device has a pair of straps on the right and left sides of the body. One set of straps further has a hook surface while the other set of straps has a loop surface. When the device is folded over itself around an invalid user inside the device, the pairs of straps meet. Pressing the ends of each strap together will then secure the hook and loop mechanisms, which form a bond between the straps. The straps may be used to attach the device to the railing of a bed to secure the position of the invalid user. Utilizing a series of pull handles that are attached to the body, a caregiver can further maneuver the invalid user. Once the desired position is achieved, the caregiver can readjust the straps around the bed railing and lock in the optimal position as needed.

Accordingly, the bed pad device of the present invention is particularly advantageous as it is made up of a durable, stain-resistant material and a detachable layer for comfort. This affords the caregiver an easy mechanism for washing and cleaning the device, the bed and the invalid user. Moreover, the invalid user will not be inconvenienced by the extended presence of the device due to its comfort and support. Therefore, this provides the caregiver the ability to maneuver the invalid user, without the need of risking any undesirable exposure to contagions, while also mitigating undesirable consequences to the invalid user, such as bed sores or festering bacteria, viruses or pathogens.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a bottom perspective view of one potential embodiment of the bed pad device of the present invention in accordance with the disclosed architecture;

FIG. 2 illustrates an enhanced bottom perspective view of one potential embodiment of the different layers of the bed pad device of the present invention in accordance with the disclosed architecture;

FIG. 3 illustrates a top perspective view of one potential embodiment of the bed pad device of the present invention folded together and secured in accordance with the disclosed architecture;

FIG. 4A illustrates a perspective view of one potential embodiment of the bed pad device of the present invention being used on an invalid user in accordance with the disclosed architecture; and

FIG. 4B illustrates a perspective view of one potential embodiment of the bed pad device of the present invention being used on an invalid user in accordance with the disclosed architecture; and

FIG. 5 illustrates a flow chart of one potential method of using the bed pad device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a bed pad device. Specifically, there exists a long-felt need in the art for a bed pad device which may be utilized to maneuver an invalid user into a desired position upon a bed. There is also a long-felt need in the art for a bed pad device that is comfortable, such that an invalid user may rest upon the bed pad for an extended period of time. There also exists a long-felt need in the art for a bed pad device which is detachable from itself, such that a caregiver may alter and clean the device as necessary. Moreover, there exists a long-felt need in the art for a bed pad that features antimicrobial and antibacterial fabrics and materials to prevent the risk of infection and disease when in use. There also exists a long-felt need in the art for a bed pad device that is durable enough for an invalid user to be moved via the device, without the risk of tearing or fraying. Lastly, there exists a long-felt need in the art for a bed pad device that features waterproof fabrics and materials.

The present invention, in one exemplary embodiment, is comprised of a bed pad device that allows a caregiver to maneuver an invalid user. The device is primarily comprised of a sheep skin layer, or other desired fabric, which may be removably or fixedly-attached to a body. The body is preferably comprised of a durable, water-resistant material, with at least one strap protruding from its rectangular center, and at least one handle attached to the center of the body. In this way, multiple caregivers may utilize the device, in the event that a heavy invalid user needs his or her position altered using the device. The at least one strap protruding from the body allows a caregiver to transition the invalid user to different positions with ease, by utilizing the leverage created when the invalid user's weight is distributed equally throughout the device.

Each of the at least one straps is fastened with a hook surface and a loop surface. A caregiver may make use of this function by uniting the two straps together and forming a locked bond that can deployed around the frame of a bed. In this manner, the device may sustain the position of the invalid user for as long as necessary. A caregiver can then pursue other goals such as cleaning the bed underneath the invalid user or cleaning the underside of the invalid user, after the user has been secured in the desired position.

In one embodiment, a sheep skin layer may be comprised of a plurality of hook and loop surfaces attached to the body and the underside of the sheep skin layer, such that the sheep skin layer may be detached. In this manner, the sheep skin layer can be removed and washed as needed. In one embodiment, the sheep skin layer may be machine washable. In other embodiments, the sheep skin layer may be made of high-quality fabrics that may require hand washing or dry cleaning. The replaceability function of the sheep skin layer also allows the caregiver to replace the sheep skin with other fabrics, that may suit a particular purpose. For example, an invalid user may require a water-resistant material due to the excretion of bodily fluids. In another embodiment, the sheep skin layer may be replaced with a stain-resistant plastic material to increase the durability of the device.

Accordingly, the bed pad device of the present invention is particularly advantageous as it allows a caregiver to easily maneuver an invalid user to accomplish certain desired purposes, without having to come in direct contact with the invalid user. The device also allows a caregiver to easily replace or clean the device, thereby eliminating the need to repeatedly seek alternative bed pad devices that must be disposed of after use. Additionally, the device is comprised of durable materials that also provide a comfortable surface for an invalid user, who may need to lay upon the device for extended periods of time.

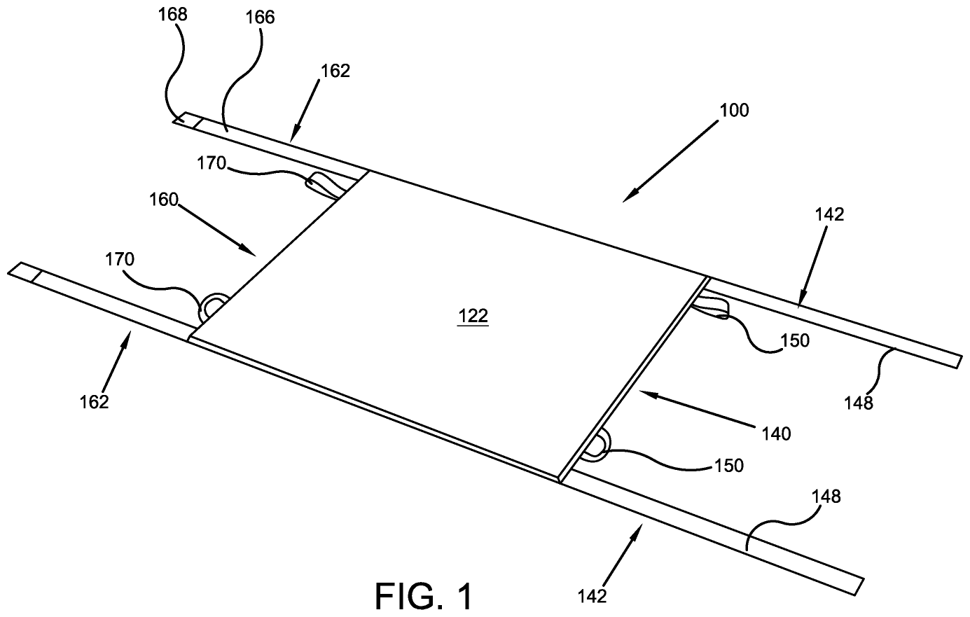

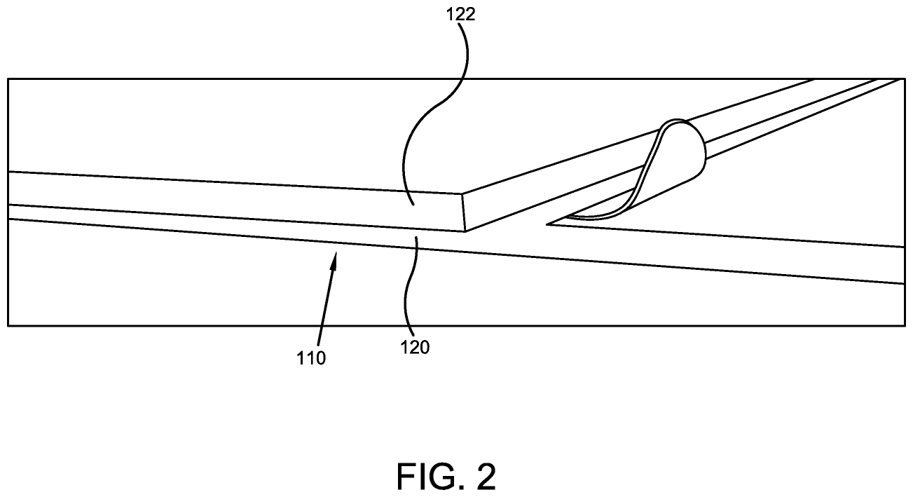

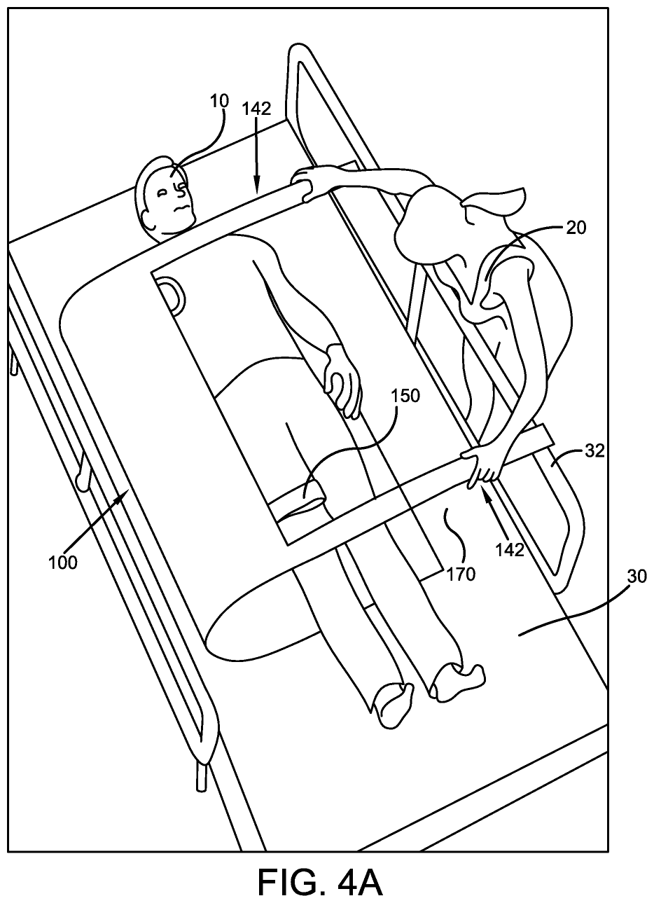

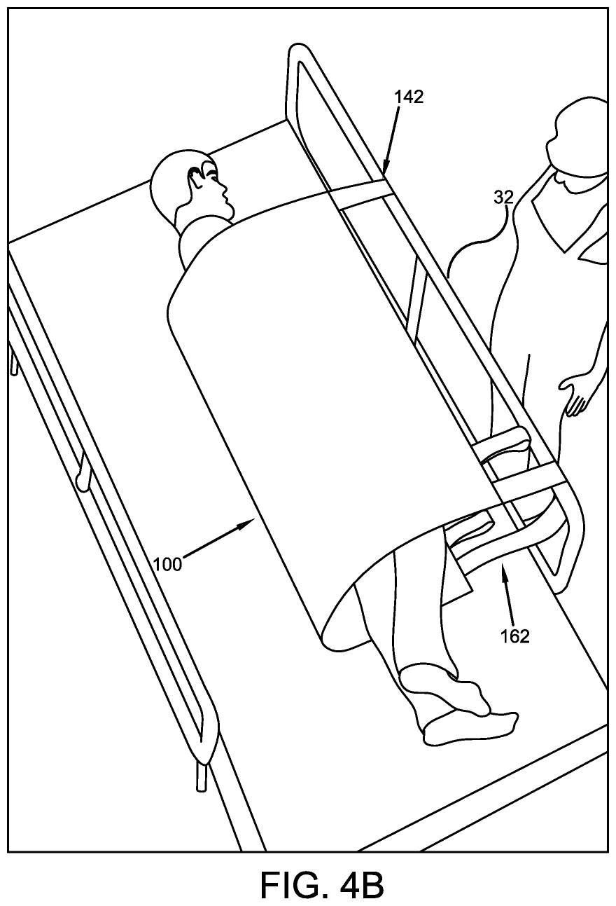

Referring initially to the drawings, FIG. 1 illustrates a bottom perspective view of one embodiment of the bed pad device 100 of the present invention. The device 100 is comprised preferably of a sheep skin layer 122, or any other suitable material as is known in the art, and fastened over a series of straps 142, 162 and surfaces which make up the body 110 (shown in FIG. 2). Specifically, at least one strap 162 protrudes from the left side of the body 160 and at least one strap 142 protrudes from the right side of the body 140. The body 110 can preferably be folded around an invalid user 10 (shown in FIG. 4), such that the second user, such as but not limited to, a caregiver 20, nurse, etc., or any other suitable person as is known in the art, may prepare to alter the invalid user's 10 position upon a bed 30. Further, at least one pull handle 170 is fastened to the left side of the body 160, while another at least one pull handle 150 is fastened to the right side of the body 140. Once an invalid user 10 is positioned on his or her side, a caregiver 20 may utilize either of the pull handles 150,170 to maneuver the invalid user 10 as necessary in any suitable position. In addition, the body 110 is preferably manufactured of a durable, waterproof and antibacterial/antimicrobial material, which is designed to prevent microorganisms, bacteria or viruses from attaching to the body 110.

FIG. 1 also illustrates the mechanisms used to form a secure connection between the straps 142, 162. Specifically, a loop surface 168 is located on the bottom surface 166 of the strap 162 on the left side of the body 160, while a hook surface 146 is located on the top surface 144 of the strap 142 on the right side of the body 140. In this manner, the device 100 is designed to be folded over itself, such that the loop surface 168 can be pressed together with the corresponding hook surface 146, forming a temporary attachment. In different embodiments, the hook and loop configuration can be fastened inversely such that a loop surface may be fastened to the top surface 144, while a hook surface can be fastened to the bottom surface 166 of either strap 142, 162.

FIG. 2 illustrates an enhanced bottom perspective view of one embodiment of the layers of the bed pad device 100 of the present invention. The sheep skin layer 122 can be fixedly or removably secured to the bottom surface 120 by a series of hook and loop surfaces, etc., or any other suitable fastener surface as is known in the art. In this manner, the sheep skin layer 122 can be separated from the body 110 for various purposes, such as but not limited to, washing, replacing, fluffing, or patching the sheep skin layer 122 as necessary. Depending on the different desired goals, such as durability, comfort and appearance, or to enhance resistance to liquid, odors, flames, stains and other noxious substances, etc., the sheep skin layer 122 can be replaced with a multitude of alternative fabrics such as, but not limited to: vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc., or any other suitable material as is known in the art. In the preferred embodiment, the sheep skin surface 122 is preferably machine washable. In other embodiments, the sheep skin layer 122 can be augmented with a waterproof spray, which fills the holes of the fabric with a substance such as wax, synthetic glue, oil, etc.

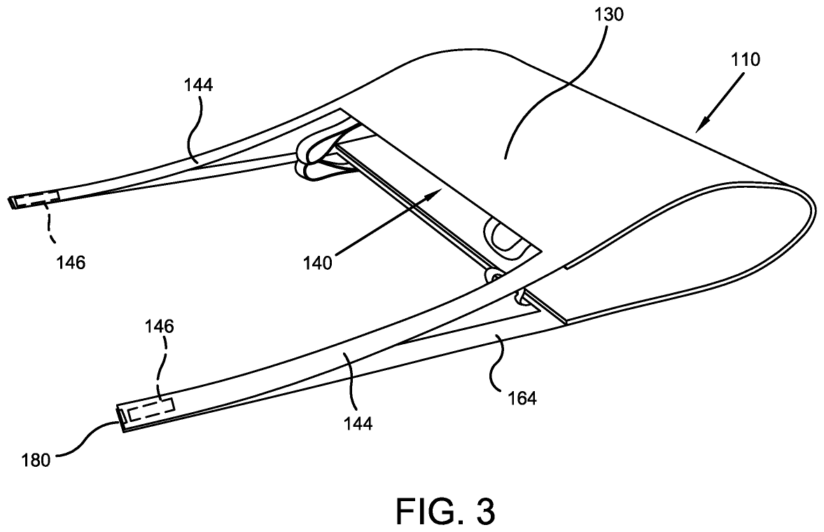

FIG. 3 illustrates a top perspective view of one embodiment of the bed pad device 100 of the present invention folded over. The body is 110 folded over itself, such that the right side of the body 140 is positioned in the same direction as the left side of the body 160 and the top surface 130 of the body 110 is facing up and away from where the caregiver 20 would be utilizing the device 100. An invalid user 10 may further be enclosed within the device 110 when folded over. The hook surface 146 can be fastened to the top surface 144 of the body, such that the hook surface can tuck into and attach itself to the top surface 164 of the opposite corresponding strap 162. Each strap 142, 162 may also be fastened with at least one magnet 180 to form said connection, or any other suitable fastening means as is known in the art can be used. The at least one magnet 180 may be any magnet type known in the art, such as but not limited to: neodymium, iron boron magnets, samarium cobalt magnets, alnico magnets, ceramic magnets, ferrite magnets, etc.

FIG. 4A illustrates a perspective view of one embodiment of the bed pad device 100 of the present invention being used on an invalid user 10. The device 100 may be placed on top of a bed 30 before use. A caregiver 20 preferably positions the device 100 under an invalid user 10. A caregiver 20 may then reach across the invalid user 10 and grab the strap(s) 142 opposite of the caregiver 20. The caregiver 20 then pulls the strap(s) 142 tightly around the railing 32 of the bed 30 to secure the device 100 in place, utilizing the hook and loop fastening functions of the straps 142, 162 as described supra. Once in position, the caregiver may utilize the pull handles 142, 150 to maneuver the invalid user 10 and/or the device 100 as necessary.

FIG. 4B illustrates a perspective view of one embodiment of the bed pad device 100 of the present invention being used on an invalid user 10. As noted above, the device 100 can be attached to a railing 32 of the bed 30 to allow the caregiver 20 to maneuver the invalid user 10 on his or her side and secure the user into the desired position, for a multitude of desired reasons, such as but not limited to, cleaning the underside of the bed 30, cleaning the underside of the invalid user 10, flipping the invalid 10 user for emergency or non-emergency health reasons, etc.

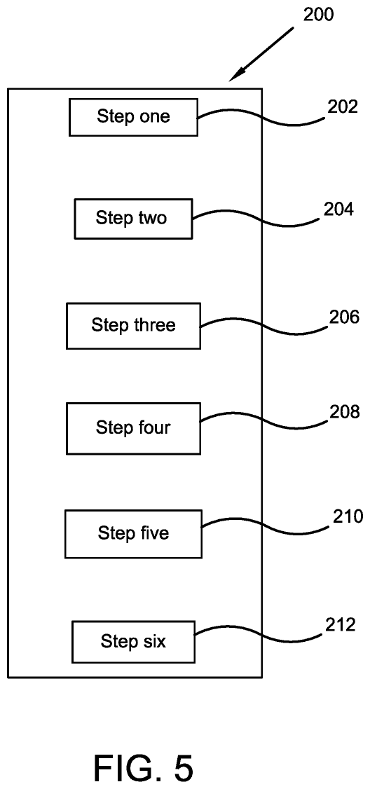

FIG. 5 illustrates a flow chart of a method 200 of using the bed pad device 100 of the present invention. One potential method 200 of utilizing the device 100 allows a caregiver 20 to maneuver the invalid user 10 onto their side. First at 202, a caregiver 20 begins by positioning the device 100 underneath the invalid user 10, with the sheep skin layer 122 facing upwards and the top surface 130 of the body 110 facing the bed 30. For the purposes of this example of method 200, the device may be positioned with the right side of the body 140 facing towards the caregiver 20 and the left side of the body 160 facing away from the caregiver 20. Then at 204, the caregiver 20 reaches across the invalid user 10 and grabs the strap 162 on the left side of the body 160 and pulls the strap 162 towards him or herself, such that the device 100 wraps around the invalid user 10 and the strap 162 from the left side of the body 160 is pointing in the same direction as the strap 142 from the right side of the body 140.

At 206, to place the invalid user 10 on his or her side, the caregiver 20 pulls the strap 162 towards him or herself as tightly as required until the device 100 rotates the invalid user 10 into the desired position. At 208, once the invalid user 10 is in a desired position, the caregiver pulls the straps 162 over the bed rail 32 and downwards to fasten the strap 162 to the other strap 142 from the right side of the body 140, utilizing the hook and loop surfaces upon each strap 142, 162. This will lock the invalid user's position in place. Next at 210, the caregiver 20 utilizes the pull handles 150, 170 to reposition the invalid user 20. Finally at 212, once the invalid user 10 is in the desired position, the caregiver 20 utilizes the hoop and loop surfaces of each strap 142, 162 to readjust the straps 142, 162, either tighter or looser as necessary around a bed railing 32.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bed pad device” and “device” are interchangeable and refer to the bed pad device 100 of the present invention.

Notwithstanding the forgoing, the bed pad device 100 of the present invention and its various components can be of any suitable size and configuration as is known in the art without affecting the overall concept of the invention, provided that they accomplish the above-stated objectives. One of ordinary skill in the art will appreciate that the size, configuration and material of the bed pad device 100 as shown in FIGS. 1-5 is for illustrative purposes only, and that many other sizes and shapes of the bed pad device 100 are well within the scope of the present disclosure. Although the dimensions of the bed pad device 100 are important design parameters for user convenience, the bed pad device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

what is claimed is:

1. A bed pad device comprising:
a body comprised of a top surface, a bottom surface, a right side, and a left side;
a first pull handle attached to the left side of the body;
a second pull handle attached to the right side of the body;
a first strap attached to the body and protruding from the left side; and
a second strap attached to the body and protruding from the right side, wherein the body is folded around an invalid user, such that a second user can alter the invalid user's position upon a bed via utilizing the first and the second straps, and further wherein once the invalid user is positioned on their side, the second user can utilize either of the first and second pull handles to maneuver the invalid user into any suitable position.

2. The bed pad device of claim 1, wherein the bottom surface of the body is comprised of a sheep skin layer.

3. The bed pad device of claim 2, wherein the sheep skin layer is removable.

4. The bed pad device of claim 2, wherein the sheep skin layer is fixedly secured to the bottom surface of the body.

5. The bed pad device of claim 1, wherein the body is manufactured of a waterproof material.

6. The bed pad device of claim 1, wherein the body is manufactured of an antibacterial/antimicrobial material.

7. The bed pad device of claim 1, wherein the bottom surface of the body is comprised of a fabric layer.

8. The bed pad device of claim 7, wherein the fabric layer is comprised of a vinyl, a canvas, a cashmere, a chenille, a chiffon, a cotton, a damask, a jersey, a lace, a linen, a wool, a modal, a polyester, a satin, a silk, a spandex, a suede, a tweed, a twill, a velvet, an acrylic, a modacrylic, a nylon, a polypropylene, a polyurethane, a polyvinyl chloride, a polyethylene, a vinylidene, a benzoate, an aramid, a rayon, an acetate or a triacetate fabric.

9. The bed pad device of claim 1, wherein the body is folded over itself, such that the right side of the body is positioned in same direction as the left side of the body and the top surface of the body is facing up and away from where the second user would be utilizing the device.

10. The bed pad device of claim 1, wherein the first and the second straps can be secured around a bed railing to secure the invalid user into said suitable position.

11. A bed pad device comprising:
a body comprised of a top surface, a bottom surface, a right side, and a left side, wherein the bottom surface of the body is comprised of a removable sheep skin layer;
a first pull handle attached to the left side of the body;
a second pull handle attached to the right side of the body;
a first strap attached to the body and protruding from the left side; and
a second strap attached to the body and protruding from the right side, wherein the body is folded around an invalid user, such that a second user can alter the invalid user's position upon a bed via utilizing the first and the second straps, wherein the first and second straps can be secured together via a plurality of hook and loop fasteners, and further wherein once the invalid user is positioned on their side, the second user can utilize either of the first and second pull handles to maneuver the invalid user into any suitable position.

12. The bed pad device of claim 11, wherein a loop surface is located on a bottom surface of the first strap on the left side of the body, while a hook surface is located on a top surface of the second strap on the right side of the body such that the bed pad device can be folded over itself to allow the loop surface to be pressed together with the corresponding hook surface to form a temporary attachment.

13. The bed pad device of claim 11, wherein a hook surface is located on a bottom surface of the first strap on the left side of the body, while a loop surface is located on a top surface of the second strap on the right side of the body such that the bed pad device can be folded over itself to allow the loop surface to be pressed together with the corresponding hook surface to form a temporary attachment.

14. The bed pad device of claim 12, wherein the first and second straps may be secured around a railing of a bed frame.

15. The bed pad device of claim 11, wherein the first and second straps can be secured to one another via at least one magnet.

16. The bed pad device of claim 11, wherein the body is manufactured of a waterproof material.

17. The bed pad device of claim 11, wherein the body is manufactured of an antibacterial/antimicrobial material.

18. The bed pad device of claim 11, wherein the bottom surface of the body is comprised of a fabric layer.

19. The bed pad device of claim 11, wherein the body is folded over itself, such that the right side of the body is positioned in same direction as the left side of the body and the top surface of the body is facing up and away from where the second user would be utilizing the device.

20. A method of using a bed pad device, the method comprising the steps of:
positioning the bed pad device underneath an invalid user, with a removable sheep skin layer facing upwards, contacting the invalid user and a top surface of a body of the bed pad device contacting a bed;
reaching, by a second user, across the invalid user and grabbing a strap that is located on a left side of the body of the bed pad device and pulling the strap towards themselves, such that the bed pad device wraps around the invalid user and the strap from the left side of the body is pointing in the same direction as a strap from a right side of the body;
the second user pulling the strap from the left side of the body towards themselves until the bed pad device rotates the invalid user into a desired position;
pulling the strap of the left side of the body over a bed railing and downwards, to fasten the strap to the right of the right side of the body;
pulling a pull handle to reposition the invalid user in a desired position; and
tightening or loosening the straps around the bed railing as necessary.
